(19) United States
(12) Patent Application Publication
(10) Pub. No.: US 2006/0111917 A1
(43) Pub. Date: May 25, 2006

(54) Method and system for transcribing speech on demand using a trascription portlet

(75) Inventor: Girish Dhanakshirur, Delray Beach, FL (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 10/992,823

(22) Filed: Nov. 19, 2004

(51) Int. Cl. G10L 11/00

(52) U.S. Cl. 704/277

(57) ABSTRACT

A method and system for transcribing speech on demand using a transcription portlet. The method can include the step of providing a transcription portlet including user data having personalized speech profiles for individual users. The transcription portlet can receive audio data. A user associated with the audio data can be identified. A personalized speech profile corresponding to the identified user can be determined. The audio data can be transcribed using the determined personalized speech profile to generate transcribed text. The transcription portlet can present the transcribed text.

### BACKGROUND

1. Field of the Invention

The present invention relates to the field of automatic speech recognition and more particularly to a method and system for transcription on demand.

2. Description of the Related Art

Computer based transcription of speech has traditionally been a client-server model application, in which transcription jobs are captured by the client and submitted to servers for processing. Speech recognition software is loaded and run on the servers. In order to use the transcription service, a user of the software must first enroll and create a user profile, typically by reading a standardized script in order that the software can recognize that user's distinctive speech patterns. The user profile is typically stored on the same server as the speech recognition software. Alternatively, the transcription itself may be done manually by a typist, and fed back into the system. Upon transcription, the results are made available in a separate database for the clients to query for the results. This type of system has a large overhead in maintaining hundreds of users and managing their enrollment data together with thousands of jobs, and cannot be utilized on demand.

Known transcription systems are difficult to scale so that a large number of users can input different audio data at the same time for retrieval. Users must typically wait while their transcription is processed, which may involve the use of manual typing and correction. This creates delays for users, which is not desirable.

For example, U.S. Pat. No. 6,122,614 to Kahn et al. (Kahn) discloses one such known transcription system. Kahn discloses a transcription server, which handles multiple users by creating a user profile in a directory system, using a sub-directory for each user. A human transcriptionist creates transcribed files for each received voice dictation file during a training period. Once a user has progressed past the training period, the dictation file is routed to a Speech Recognition Program. A transcription session is run, and any speech adaptation is done by manually correcting the text and sending it for correction. Such a speech recognition system, using a particular user's speech profile, has to be run on the system where the particular user's directory exists. In addition, the system described in this reference is a batch mode system where the data is submitted, queued, and then run at a time convenient for the server.

### SUMMARY OF THE INVENTION

The present invention provides a computer-implemented method and system for automatic speech recognition (ASR) text transcription on demand.

One aspect of the invention relates to a method which includes providing a transcription portlet including user data having personalized speech profiles for individual users. The transcription portlet can receive audio data. A user associated with the audio data can be identified. A personalized speech profile corresponding to the identified user can be determined. The audio data can be transcribed using the determined personalized speech profile to generate transcribed text. The transcription portlet can present the transcribed text.

Another aspect of the present invention relates to a transcription system which includes a Web portal and at least one transcription server. The Web portal can include a transcription portlet that is configured for receiving user provided audio data, using at least one transcription server to transcribe the audio data into transcribed text, and presenting the transcribed text to a user that provided the audio data.

It should be noted that the invention can be implemented as a program for controlling a computer to implement the functions described herein, or a program for enabling a computer to perform the process corresponding to the steps disclosed herein. This program may be provided by storing the program in a magnetic disk, an optical disk, a semiconductor memory, any other recording medium, or distributed via a network.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a multimodal communication environment in which a system according to one embodiment of the present invention can be used.

FIG. 2 is a schematic diagram of a system according to one embodiment of the present invention.

FIG. 3 is a flowchart illustrating a method according to another embodiment of the present invention.

FIG. 4 is an illustrative image of a Web interface suitable for viewing transcription results.

### DETAILED DESCRIPTION OF THE INVENTION

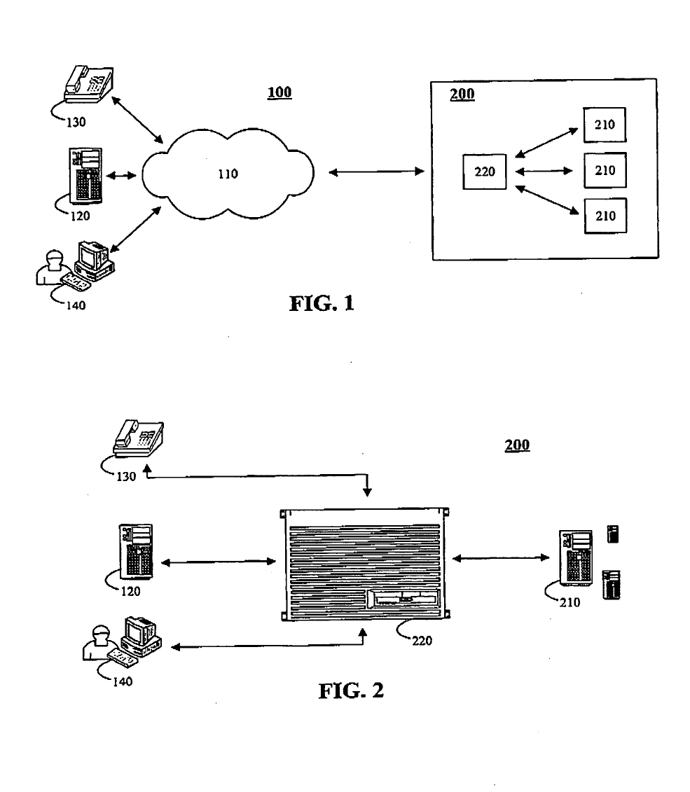

FIG. 1 is a schematic diagram illustrating a multimodal communications environment 100 in which a system 200 for transcribing speech on demand can be used, according to the present invention. As illustrated, the communication environment 100 can include a communications network 110. The communications network 110 can include, but is not limited to, a local area network, a wide area network, a public switched telephone network, a wireless or mobile communications network, or the Internet. Illustratively, the system 200 is also able to electronically communicate via another or the same communications network 110 to a computer system 120 and to a telephone 130 for transcription input and output. The system 200 is also able to electronically communicate with a computer system 140 operated by a correctionist, for correcting transcribed speech.

It will be readily apparent from the ensuing description that the illustrated multimodal communications environment 100 is but one type of multimodal communications environment in which the system 200 can be advantageously employed. Alternative multimodal communications environments, for example, can include various subsets of the different components illustratively shown.

Referring additionally to FIG. 2, the system 200 illustratively includes one or more transcription servers 210, and a Web/portal server 220. The transcription servers 210 have an automatic speech recognition (ASR) engine loaded thereon. Any suitable ASR may be used, such as IBM's Recognition Engine software. The Web/portal server 220 has a portal server application loaded onto it, such as IBM's WebSphere Portal Server software. Additionally, a transcription portlet is loaded on the Web/portal server, which controls the flow of data between the components of the system 200. One or more communications devices and an application program interface (API) through which the application program is linked may also be included.

It should be appreciated that the arrangements shown in FIG. 2 are for illustrative purposes only and that the invention is not limited in this regard. The functionality attributable to the various components can be combined or separated in a different manner than those illustrated herein. For instance, the portal server and the transcription portlet can be implemented as a single software component in another arrangement of the present invention. The illustrated communications components are representative only, and it should be appreciated that any communications component capable of sending and/or receiving an audio file and/or transcribed text can be utilized in arrangements of the present invention.

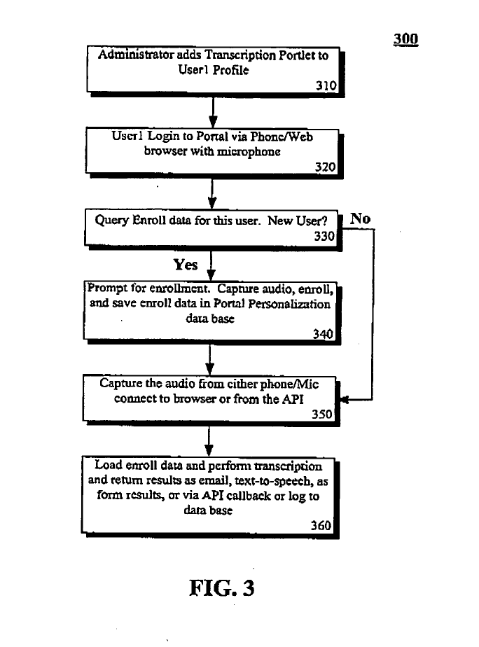

FIG. 3 is a flow chart illustrating a method 300 of speech transcription according to aspects of the present invention. If a user wishes to have audio data transcribed into text, the user can request access to the system 200. The method 300 can begin at step 310. In step 310 an administrator adds a transcription portlet to the user's profile. This step can also be achieved by the user joining the system 200, for example, by logging on to an Internet based application, and setting up their own profile following prompts. In step 320, once the transcription portlet has been added to the user's profile, the user logs in to the portal. The user may use any suitable communications device to log in to the portal, including but not limited to a telephone, a mobile telephone with a Web browser, a computer with microphone attached, a personal digital assistant (PDA), etc.

The portal server program (not shown) queries the enrollment data for the user in step 330. If the user is a new user of the system, they are prompted for enrollment. The enrollment process may include capturing a scripted audio file for creation of the user's personalization profile. The script may be displayed to the user in the user's Web browser or may be sent to the user in any suitable means, such as by e-mail. The user reads the script and sends the captured audio file to the system 200. The audio file is collected and enrollment is run for the user on the speech recognition engine to create a speech profile for the user in their enrollment data. The enrollment data is saved in the Portal Personalization database.

Once a user has been enrolled, the user may begin to upload the audio data that is to be transcribed. In step 340 the audio data is captured from either the telephone or the microphone connected to the browser, or from the API. The audio may be captured by any suitable means, and the system is preferably multi-modal so that a user can select any appropriate audio capture means that the user wishes to use, and the invention advantageously is not limited in this regard. It will be understood that any application which has audio capabilities can use the transcription portlet loaded on the portal server to forward the audio file to the transcription server. The audio may be captured by the portlet using any suitable voice capture program, such as IBM's WebSphere Voice Server.

For example, the voice server may run a program, such as VoiceXML over the telephone, or the system may use an applet that captures the audio. In another example, the audio may be attached to an email and sent to a voice server or other suitable server or application. For instance, in one arrangement, a mail application can capture audio from an audio source, can transcribe the captured audio into text, and can convey the captured audio and/or transcribed text via email as an attachment. It should be noted that the system as described can advantageously use VoiceXML without the need for any extensions.

In step 350, the transcription portlet loads the user speech profile from the Portal Personalization database and starts a transcription session by sending the audio file and the user speech profile to the transcription server 210. The user data is stored on the portal server 220, and is fed to the transcription server 210 only at the time that a job is to be run on the transcription server. Thus, any number of transcription servers 210 may be connected to the system 200, and the portal server 220 can route the transcription job to any suitable transcription server 210 in order to receive the transcription results in the quickest possible time. This enables the system to be scaled easily so that a large number of users can request transcription at the same time, because more transcription servers 210 can be added to the system 200 as the need arises, without any requirement of copying and updating the Portal Personalization database containing the user profiles to each server.

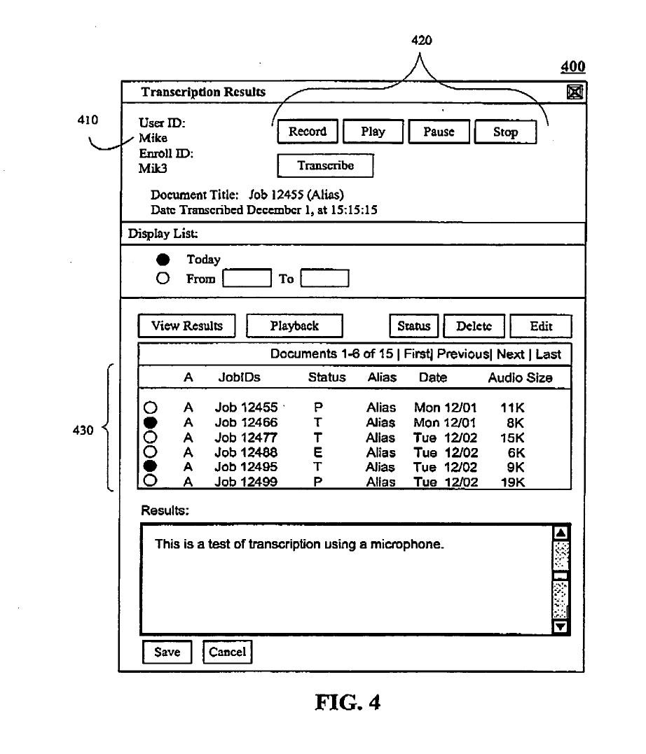

The portal server 220 also handles a GUI portlet for correction/updating of the user profile. The results are returned to the user either via email, a Web browser, Text-to-Speech, as form results, or via API callback or as a log to a database. The transcribed text may be transmitted to the user in any desired format, such as html. A user, for example using a computer 120, can then view the transcription results. The results may be displayed using a Web interface 400, such as that shown illustratively in FIG. 4. The Web interface 400 may include user ID data 410, audio input buttons 420 to operate a microphone attached to the computer running the Web interface, transcription job lists 430 and other data. Alternatively, the results may be fed back to the same interface that the user uses to upload the audio data. This can be useful in many instances, for example, a physician may view images, such as patient scans, using an image viewing portal. The image viewing portal may include an audio portal that the physician may use for dictation of notes while viewing the images. The transcribed text can be returned to the audio portal from the Web/portal server quickly enough and in near real-time such that the physician can review the transcribed text while the images are still on screen. The physician can then review the text and save the results to the patient's file, or can delegate the correction of any errors to a correctionist. In another example, the system 200 can be used to reduce bandwidth when a user desires to reply to an e-mail using voice. If audio files are recorded and sent with the e-mail, this requires a large bandwidth to transfer the audio files between users. Using the transcription portlet, the email Portlet can capture audio and send it to the transcription system 200 to transcribe the audio and email only the text.

The system 200 improves its accuracy over time by adaptation. A correctionist 260 may log in to the system 200, and may correct the transcribed text. Checking by a correctionist may be carried out on a random basis, or may be done for the first few documents for a particular user that are transcribed by the system. As corrections are made to documents, the corrections are used to adapt and update the user's speech profile for improved accuracy. Alternatively, or in addition, the user may correct the document upon receipt, and may upload the corrections for review either by the system or by a correctionist. Yet further, the user may record a second audio file with the corrections which may be uploaded to the system with the transcribed text for correction of the errors. The corrections are sent back to the recognition engine, which runs a correction session against the data, and the resulting user data is saved to the Portal Personalization database so that the user's personalized speech profile is updated for use on the next transcription job for that user.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A computer-implemented transcription method comprising the steps of:
providing a transcription portlet including user data having personalized speech profiles for individual users;
the transcription portlet receiving audio data;
identifying a user associated with the audio data;
determining a personalized speech profile corresponding to the identified user;
transcribing the audio data using the determined personalized speech profile to generate transcribed text; and
the transcription portlet presenting the transcribed text.

2. The method of claim 1, wherein the transcription portlet provides a multimodal interface.

3. The method of claim 2, further comprising the steps of:
when a communication is established between the transcription portlet and a user, determining a communication type for the communication; and
automatically adjusting the modality of the transcription portal in accordance with the determined communication type.

4. The method of claim 2, wherein the transcription portlet interfaces with a telephony device via a voice connection, wherein the audio data is received over the voice connection.

5. The method of claim 2, wherein the transcription portlet is rendered within a Web browser as a multimodal Web browser interface.

6. The method of claim 2, wherein one of the multimodal interfaces is an application program interface.

7. The method of claim 1, further comprising the steps of:
identifying a user selected text output format; and
the transcription portal presenting the transcribed text in accordance with the user selected text output format.

8. The method of claim 1, wherein the receiving, the identifying, the determining, the transcribing, and presenting steps are performed during a single communication session in which a user accesses the transcription portal.

9. The method of claim 1, wherein the at least one transcription server comprises a plurality of transcription servers, said method further comprising the step of:
the transcription portlet selecting a transcription server from the plurality based on availability, wherein the identifying and determining steps are performed by the transcription portlet.

10. A machine-readable storage having stored thereon, a computer program having a plurality of code sections, said code sections executable by a machine for causing the machine to perform the steps of:
providing a transcription portlet including user data having personalized speech profiles for individual users;
the transcription portlet receiving audio data;
identifying a user associated with the audio data;
determining a personalized speech profile corresponding to the identified user;
transcribing the audio data using the determined personalized speech profile to generate transcribed text; and
the transcription portlet presenting the transcribed text.

11. A transcription system comprising:
a Web portal including a transcription portlet; and
at least one transcription server, said transcription portlet configured for receiving user provided audio data, using the at least one transcription server to transcribe the audio data into transcribed text, and presenting the transcribed text to a user that provided the audio data.

12. The system of claim 11, wherein the transcription portlet is a multimodal portlet configured to selectively interface with users via an audible interface and via a graphical user interface.

13. The system of claim 12, wherein the transcription portlet is accessible via a telephony device, wherein the transcription portlet interfaces with a user of the telephony device using an audible interface.

14. The system of claim 12, wherein graphical user interface includes a Web browser.

15. The system of claim 14, wherein the transcription portlet provides a multimodal interface to Web browser users.

16. The system of claim 11, wherein the transcription portlet presents the transcribed text in at least one of real-time and near-real time.

17. The system of claim 11, wherein the transcription server utilizes a personalized speech profile associated with a user that provided the audio data to transcribe the audio data into transcribed text so that the presented transcribed text is personalized for the user.

18. The system of claim 17, wherein the transcription portlet identifies a user associated with the user provided audio data, wherein the at least one transcription server determines the personalized speech profile based upon the user identity provided by the transcription portlet.

19. The system of claim 17, comprising means for receiving user provided feedback pertaining to the transcribed text, such that the feedback results in an update of the personalized speech profile used to generate the transcribed text.

20. The system of claim 11, wherein the at least one transcription server comprises a plurality of transcription servers, wherein the Web portal includes a program to select which transcription server is to produce the transcribed text based on transcription server availability.
